(19) United States
(12) Patent Application Publication
(10) Pub. No.: US 2004/0033832 A1
(43) Pub. Date: Feb. 19, 2004

(54) Casino money handling system

(76) Inventor: Gregg Solomon, Henderson, NV (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/217,530

(22) Filed: Aug. 13, 2002

(51) Int. Cl. A63F 13/00

(52) U.S. Cl. 463/25; 463/29

(57) ABSTRACT

The subject invention provides a closed system for counting monetary instruments from a plurality of games within a casino. The system includes a universal box for insertion into one of the games and for storing monetary instruments inserted into the game. A memory device is coupled to the universal box and the memory device is adapted to receive data from the game. The system further includes a bill validator for accepting and validating the monetary instruments such that the bill validator is adapted to communicate the game identification to the universal box. The system further includes a counting machine for receiving the monetary instruments stored in the universal box and the game identification from the memory device. The counting machine associates the monetary instruments that are counted with the data and transmits to a network for real-time tracking of the money within the casino.

### BACKGROUND OF THE INVENTION

1. Field of the Invention

A system and a method for counting monetary instruments from a plurality of games, specifically for producing a real-time count of the moneys received in a casino from the plurality of games.

2. Description of the Related Art

The related art systems include boxes for insertion into games and for storing currency inserted into the games. A bill validator accepts and validates the currency and then the currency is stored within the box. The bill validator is adapted to distribute a predetermined currency from the bill validator. One such system is illustrated in U.S. Pat. No. 6,264,556 to Izawa et al. and assigned to Japan Cash Machine Co., Ltd. The '556 Patent discloses a gaming machine, such as a slot machine, including a bill validator to accept paper currency and a note hopper for dispensing paper currency as a portion of the payout.

Another prior art system is disclosed in U.S. Pat. Nos. 6,125,988 to Waters and 6,059,090 to Davis et al., both assigned to Agent Systems, Inc. The '988 Patent discloses a system and method for providing accounting and for collection of monies in a plurality of stations. The '090 Patent discloses a configurable cash box for use in the systems of the '988 Patent. The system includes fare boxes which receives fares from bus riders. The fare boxes store data relating to an amount of money inserted into the box and other information as desired. The data is then downloaded from the fare boxes to a computer network through a wireless link. The cash box includes a cash box indicator specific to the cash box such as a serial number. The cash box is removed from the fare box and the money in the cash box is counted and loaded into the computer network. Once in the network, the money actually counted from the cash box is compared to the value of the money downloaded from the fare box.

The related art systems are characterized by one or more inadequacies. The related art systems require additional memory devices and indicators for linking the currency actually counted from the cash box with the data. Further the related art boxes do not prevent the boxes from being returned to system without the currency being removed which allows for increased operating errors, and possible theft of the currency, and require handling of the currency by one or more persons. Also, the related art systems do not provide real-time tracking of the currency from each of the stations.

The present invention is aimed at one or more of the problems set forth above.

### SUMMARY OF THE INVENTION AND ADVANTAGES

In one aspect of the present invention, a system for counting monetary instruments from a plurality of games, is provided. The system includes a box for insertion into one of the games and for storing monetary instruments inserted into the one game. A bill validator accepts and validates the monetary instruments and is adapted to communicate data related to the one game to the box. The bill validator may also recycle or pay out monetary instruments to a player. A memory device receives the data and stores the data when the box is inserted into the game. A counting machine receives the monetary instruments stored in the box and the data, counts the monetary instruments, responsively determines a value, and associates the data with the value.

In another aspect of the present invention, a method for counting monetary instruments from a plurality of games is provided. The method includes the steps of inserting a box into one of the games, and accepting and validating the monetary instruments inserted into the one game using a bill validator. The method may also include the step of paying out monetary instruments to a player as needed.

Accordingly, the subject invention overcomes the inadequacies of the related art systems. The subject invention has reduced monetary instrument handling and minimizes the number of people who have access to the monetary instruments. Also, the subject invention tracks the money instruments on a game by game basis and provides a real-time tracking system for the monetary instruments moving throughout the casino. Thus, the subject invention eliminates access to any monetary instruments stored within the box from unauthorized personnel.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is an illustration of the system of the subject invention;

FIG. 2 is a perspective view of a slot machine for use with the subject invention;

FIG. 3 is a perspective view of a game table for use with the subject invention;

FIG. 4 is a perspective view of a box according to the subject invention;

FIG. 5 is a perspective view of the box of FIG. 4 engaging a docking station for downloading the data from the box;

FIG. 6 is a perspective view of a counting machine having a receiving station for engaging the box of FIG. 4;

FIG. 7 is a perspective view of a docking station according to the subject invention;

FIG. 8 is a flowchart depicting a method according to the subject invention;

FIG. 9 is a flowchart depicting an alternate method according to the subject invention; and

FIG. 10 is a perspective view of a receipt having a bar code to be scanned by a counting machine according to the subject invention.

### DETAILED DESCRIPTION OF THE INVENTION

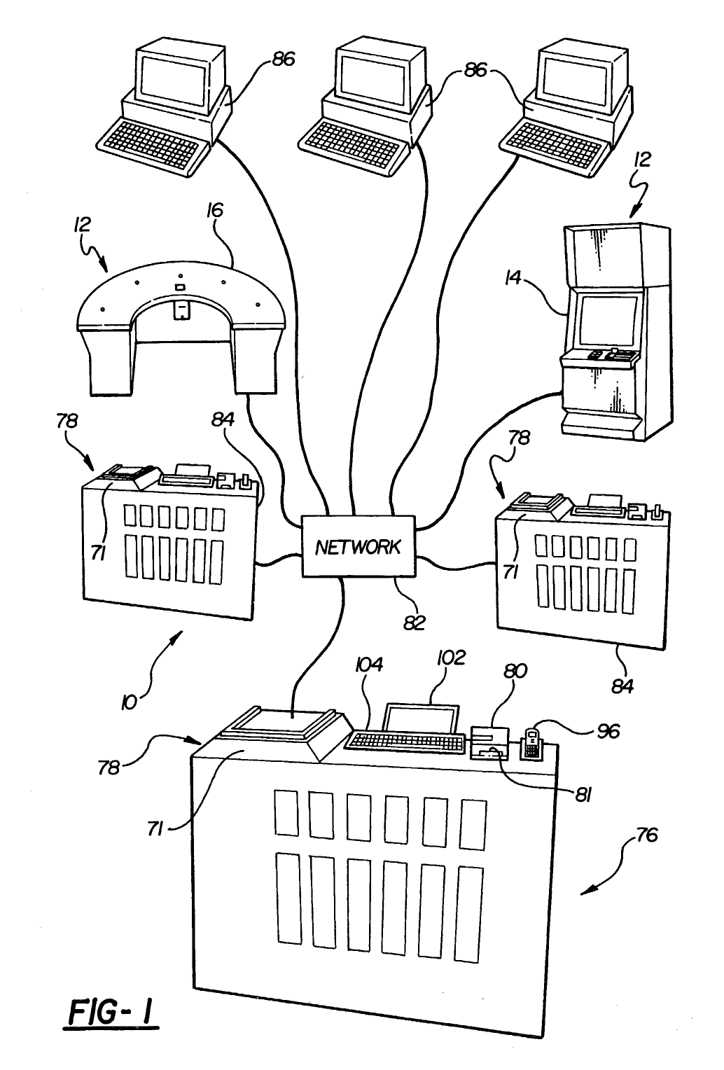

Referring to the Figures, wherein like numerals indicate like or corresponding parts throughout the several views, a closed system for counting monetary instruments (including, but not limited to, currency, coin, tokens, coupons, or other cash equivalents) from a plurality of games is disclosed at 10 in FIG. 1. As discussed below, the closed system 10 uses a universal cash box. The plurality of games 12 includes those games 12 typically played at casino, such as slot machines 14 and game tables 16 as shown in FIGS. 1, 2, and 3, respectively.

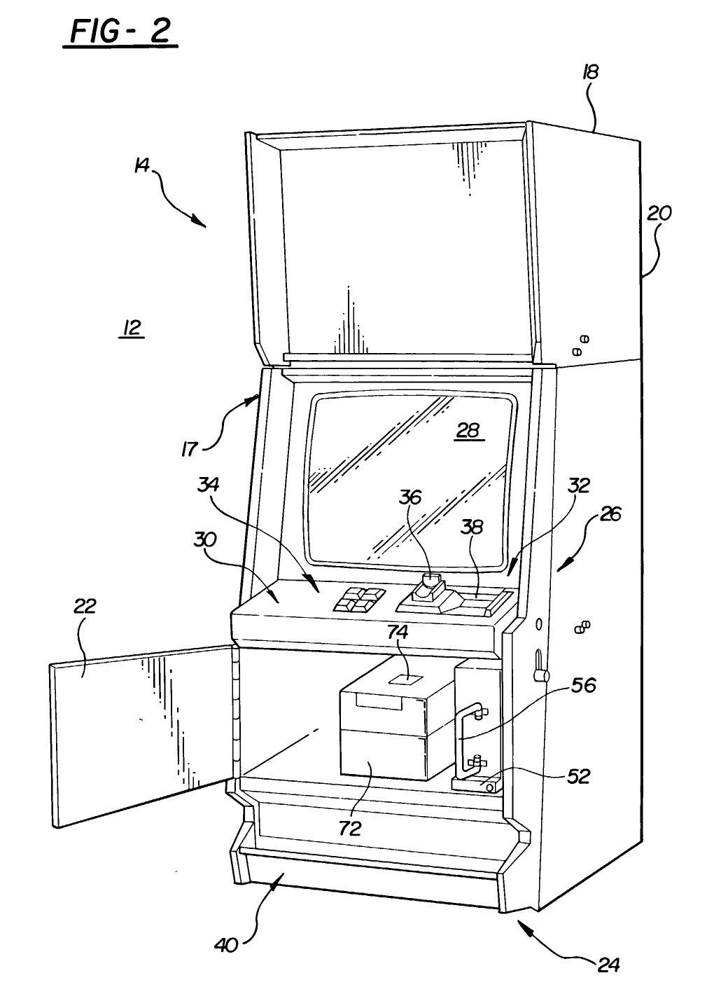

The slot machine 14 in FIG. 2 illustrates the subject invention incorporated to improve the tracking and handling of money paid into the games 12 in the form of monetary instruments. FIG. 2 shows a general appearance of the slot machine 14 to which the present invention is applied. As shown in FIG. 2, the slot machine 14 includes a housing standing upright. The housing includes a main body 17, a top box 18 mounted on a top portion 20 of the main body 17 and a door 22 attached to a front side 24 of the main body 17 so as to be swingable between an open position and a closed position. At a center portion 26 of the front side 24 of the main body 17, there is mounted a main display device 28 comprising a CRT, and below the display 28 is provided an operation panel 30.

As shown in FIG. 2, the operation panel 30 is provided, from a right end toward a left end thereof, with an insertion portion 32, and an input portion 34. The insertion portion 32 is provided with a slot base integrally formed with a coin insertion portion 36 and a bill insertion portion 38. FIG. 2 also illustrates a monetary instrument bin 40 which receives the monetary instrument paid to the player.

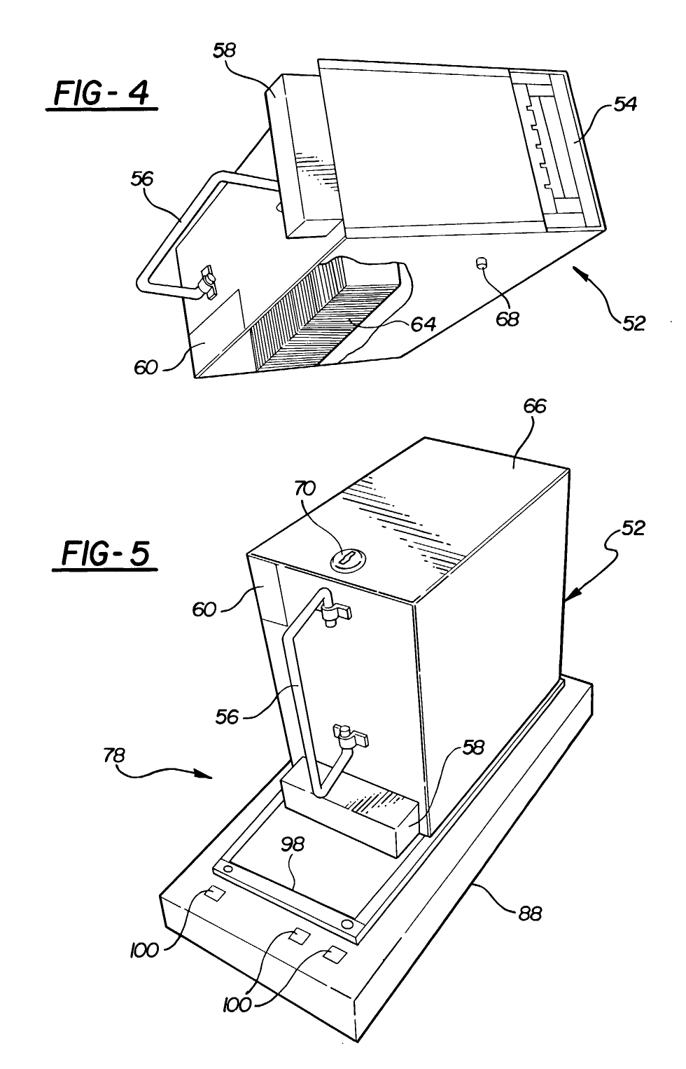

Referring to FIG. 4, the closed system 10 includes a universal box 52 for insertion into one of the games 12 and for storing monetary instruments inserted into the one game 12. The universal box 52 has a connector 54 for engaging the games 12. The connector 54 is preferably located on the bottom of the universal box 52 such that the connector 54 connects the universal box 52 to the game 12 as the universal box 52 slides into the game 12. The connector 54 may include a contact or a non-contact connector. Suitable connectors 54 (contact and non-contact) include, but are not limited to, serial, parallel, USB, infrared, or radio frequency connectors. The universal box 52 has a handle 56 for facilitating removal, insertion, and transportation of the universal box 52.

A memory device 58 is coupled to the universal box 52 and the memory device 58 is adapted to receive data from the game 12. The data may include game identification or other content information stored in the game 12. Such other content information may include the amount of money received and paid out. For example, the content information may also include the specific denominations of bills received, dates, and times. It is to be understood that the memory device 58 could be any type of memory that allows for writing and rewriting to the memory device 58. Preferably, the memory device 58 is connected to the connector 54 such that the connector 54 transmits data to the memory device 58. The memory device 58 is adapted to be erased for insertion into another of the games 12 after the monetary instruments has been removed. The memory device 58 stores the game identification when the universal box 52 is inserted into the game 12. The memory device 58 has an initial value, such as no game identification, and receives the game identification associated with the game 12 upon an initial insertion of the universal box 52 into the game 12. The memory device 58 is erased and reset before insertion into a different game.

The universal box 52 may also include a display 60 for indicating messages to personnel who handle the universal box 52. It is to be understood that the display 60 may be any type of display 60 as is known in the art of displaying messaging. In the preferred embodiment, the display 60 indicates error messages. The closed system 10 further includes an indicator 62, shown in FIG. 2, coupled to the one of the games 12 for indicating an error condition and a non-error condition. The error condition being defined as the insertion of the universal box 52 into another of the games 12 where the game identification stored on the memory device 58 is different than a game identification associated with the another of the games 12. The non-error condition being defined as the insertion of the universal box 52 into the one of the games 12 where the game identification stored on the memory device 58 is equal to a game identification associated with the one of the games 12 or the initial value. Also, the memory device 58 may generate an error signal when inserted into a different game prior to being reset. When the memory device 58 has a different game identification than that of the game 12, an error message may be displayed as described above. The error message maybe shown on the display 60, as an LED, or as an audible alarm.

The universal box 52 has a holding chamber 64 for storing monetary instruments inserted into the game 12. The holding chamber 64 may be a single chamber for stacking the monetary instruments or may be divided into multiple slots. For example, if the monetary instruments are currency, than each of the slots may receive a different denomination of currency, such as one dollar bills, five dollar bills, etc. The holding chamber 64 may also include slots for only a predetermined number of denominations, such as slots for ten dollar bills and twenty dollar bills and a slot for all other denominations.

Referring to FIG. 5, the access panel 66 may also include a locking mechanism 70 for locking the access panel 66. The locking mechanism 70 may be either a mechanical lock or an electronic lock. The locking mechanism 70 may include a single key lock or multiple key locks for preventing unauthorized entry in to the universal box 52. Alternately, the access panel 66 may include the electronic lock coupled to the universal box 52 for locking the access panel 66 to prevent unauthorized removal of the monetary instruments stored in the holding chamber 64 (see FIG. 4). It is to be understood that the access panel 66 may also be equipped with either the mechanical lock, the electronic lock or both.

Referring back to FIGS. 2 and 4, the universal box 52 further includes a bill validator 72 for accepting and validating the monetary instruments such that the bill validator 72 is adapted to communicate the game identification to the universal box 52. The bill validator 72 is connected to the bill insertion portion 38 for inserting the monetary instrument into the game 12. The bill insertion portion 38, as is known in the art, accepts the monetary instruments and the monetary instruments are validated by the bill validator 72. The bill validator 72 further includes a memory source 74 that stores a game identification for the specific game. The game identification is preferably related to the one game. As an example, in a casino environment, the game identification would include the specific game type and the specific game machine running the specific game type. The bill validator 72 also includes a holding chamber (not shown) for storing monetary instruments to be dispensed to the player as needed. If the bill validator 72 becomes full, then all incoming monetary instrument is diverted to the universal cash box 52.

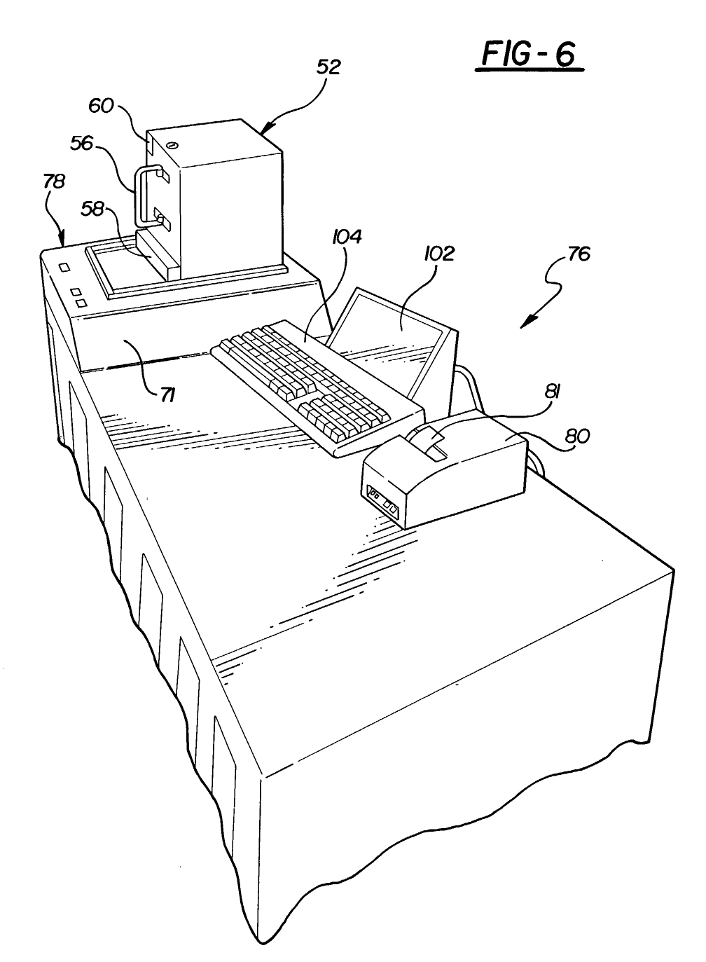

Referring to FIG. 6, the universal box 56 further includes a counting machine 76 for receiving the monetary instruments stored in the universal box 52 and the game identification from the memory device 58. The counting machine 76 associates the monetary instruments that are counted with the game identification. For example, the counting machine 76, as known in the art, may receive a stack of bills and responsively determine a value for the currency. In one embodiment, the counting machine 76 includes a receptacle 71 for receiving the monetary instruments from the universal box 52 and a receiving station 78 coupled to the counting machine 76 adapted to receive the universal box 52. The receiving station 78 receives the universal box 52, downloads the data stored in the memory 58 and links the data with the counted monetary instruments. If the universal box 52 is equipped with the electronic lock, the receiving station 78 is able to automatically unlock the electronic lock when the universal box 52 is inserted into the receiving station 78.

The receiving station 78 is positioned relative to the receptacle 71 such that the monetary instruments enter the receptacle 71 after the electronic lock is unlocked for counting. The receiving station 78 is also capable of erasing the data stored on the memory device 58 to prepare the universal box 52 for reinsertion into the same or other games 12. The receiving station 78 prevents unauthorized access to the monetary instruments stored in the holding chamber 64 (see FIG. 4) of the universal box 52. A printer 80 may also be connected to the counting machine 76 for printing a receipt 81 for having a hard copy of the monetary instruments and data associated. The counting machine 76 may also include a terminal display 104 and keyboard 106 for inputting additional data relating to any of the universal boxes.

After the counting machine 76 has counted the monetary instruments, the value and game identification are linked and transmitted to a network 82. It is to be understood that the network 82 is linked to as many other electronic devices as desired, as shown in FIG. 1. For example, the network 82 may be connected to other counting machines 84 and other computer terminals 86. The networked information allows the casino to track the flow of money throughout the casino for each of the games 12.

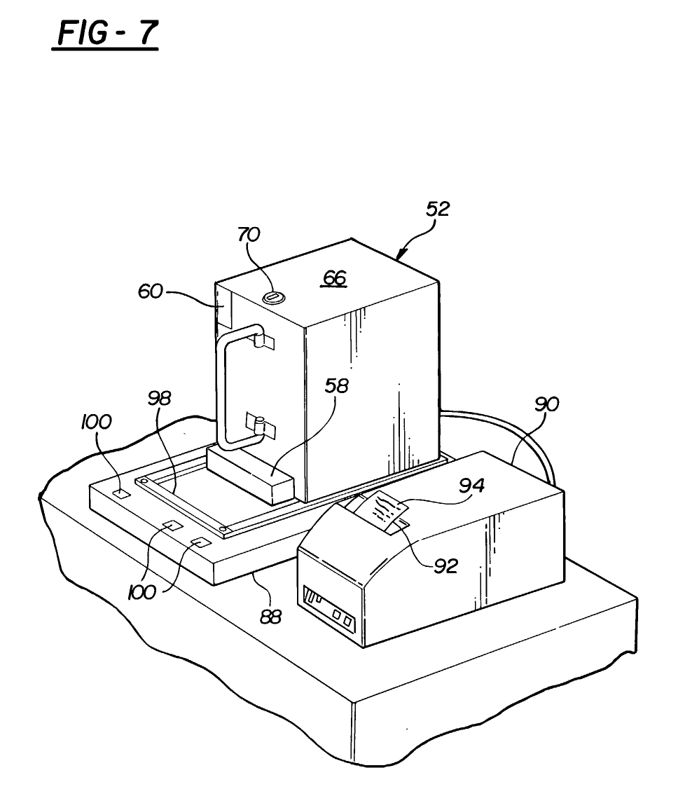

Referring to FIG. 5, the receiving station 78 may alternatively include a docking station 88 for receiving the universal box 52 and reading the game identification from the memory device 58. A printer 90 for printing a receipt 92 having a bar code 94 is also coupled to the docking station 88 (see FIG. 7). The receipt 92 is illustrated in FIG. 10. The receipt 92 may include additional information such as the date and time of downloading, an identity of the counting machine 76, etc. The bar code 94 represents the game identification stored on the memory device 58. As shown in FIG. 1, a bar code reader 96 is coupled to the counting machine 76 for reading the bar code 94 and associating the game identification with the monetary instruments counted.

Returning to FIG. 7, the docking station 88 includes connectors 98 for contacting to the connector 54 of the universal box 52. Once the connector 54 of the universal box 52 contacts the connectors 98 of the docking station 88, the docking station 88 downloads the game identification from the memory device 58 and erases the memory device 58. The docking station 88 also includes status indicators 100 for indicating the status of the download of the game identification. The status indicators 100 may also be mirrored onto the display 60 of the universal box 52 while downloading. As each cash universal box 52 reaches the predetermined limit or at predetermined intervals, the universal box 52 is removed and the monetary instruments are counted. Once these are linked together, they are available as a real-time count of the money that the casino has received. The data may then be incorporated into other accounting features that are necessary for the casino.

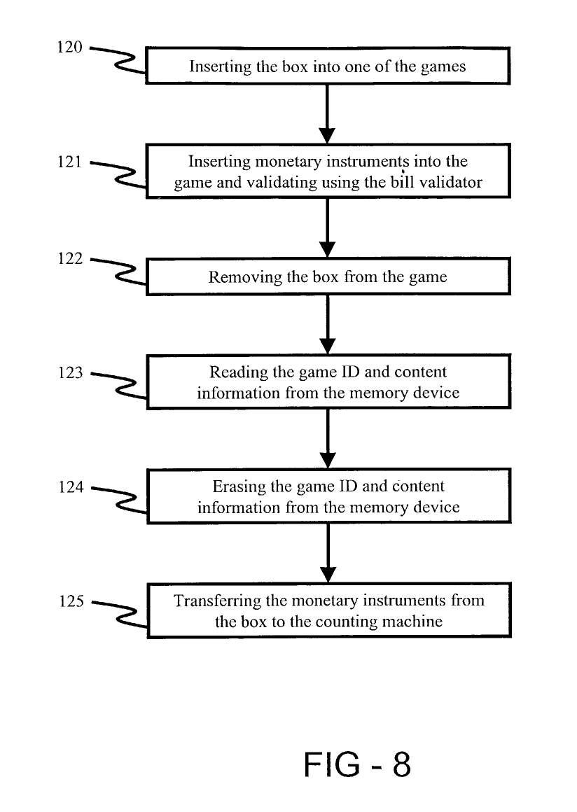

Referring to FIG. 8, a method for counting monetary instruments from a plurality of games 12 is provided. In a first step 120, the box 52 is inserted into one of the games 12. The game identification (ID) is communicated from the bill validator 72 to the box 52 and stored on the memory device 58 when the box 52 is inserted into the game 12. In a second step 121, monetary instruments are inserted into the game and validated using the bill validator 72. The monetary instruments are stored either within the box 52 or the bill validator 72. Monetary instruments stored in the ball validator may be paid to a player as needed. In a third step 122, the box 52 is removed from the game 12.

In a fourth step 123, the game ID and content information are read from the memory device 58. In a fifth step 124, the game ID and content information are erased from the memory device 58. In a sixth step 125, the monetary instruments are transferred from the box 52 to the counting machine 76.

In one embodiment as described above, the box 52 is inserted into the docking station 88 which reads the game ID and content information and erases the game ID and content information from the memory device 58. The docking station 88 prints a ticket contained the game ID and the content information. The monetary instruments are removed from the box 52 and inserted into the counting machine 76 which reads the ticket, counts the monetary instruments and associates the counted value with the game ID and content information.

In another embodiment, the docking station 88 is coupled to the counting machine 76. The docking station 88 reads the game ID and content information and sends it directly to the counting machine 76.

The counting machine 76 has the receptacle 71 positioned relative to the receiving station 78 such that the monetary instruments enter the receptacle 71. After the universal box 52 is inserted, the electronic lock is unlocked and the access panel 66 is opened depositing the monetary instruments into the receptacle 71. The monetary instruments are counted using the counting machine 76 and responsively determines a value for the counted monetary instruments. The counting machine 76 reads the game identification from the universal box 52 and associates the gaming identification with the value. The universal box 52 includes a green light which once connected to the receiving station 78 begins to blink. While the green light is blinking, the data on the memory device 58 is being downloaded. The universal box 52 should not be removed while the light is blinking. The green light will become solid once the data is completely downloaded. The receipt is then printed indicating the machine number, universal box number, date, time, and bar code. The counting machine 76 then erases the memory device 58 of the universal box 52.

The step of transferring the monetary instruments from the universal box 52 may alternatively include inserting the universal box 52 into the docking station 88. The docking station 88 receives the universal box 52 and downloads the game identification from the memory device 58. The docking station 88 may also print the receipt 92 having the bar code 94 containing the game identification. The universal box 52 is then transferred from the docking station 88 to the counting machine 76. It is to be understood that the monetary instruments may be removed from the universal box 52 while still connected to the docking station 88. The bar code reader 96 coupled to the counting machine 76 is used to scan the bar code 94 on the receipt 92. The monetary instruments are deposited into the counting machine 76 and the monetary instruments are counted and linked to the game identification from the bar code 94. The universal box 52 is inserted into one of the games 12 and the universal box 52 indicates an error if the memory device 58 contains a different game identification than that of the bill validator 72.

The method further includes the step of paying out monetary instruments to a player via the bill validator 72. In order to pay out to the player, the memory device 58 may store the amounts and denominations paid out since the last time the universal box 52 was removed. The memory device 58 tracks and recycles the monetary instruments as the game 12 pays out to the player and as the game 12 continues to receive monetary instruments. The game 12 pays out monetary instruments as desired from the bill validator 72. One such form of other currency which may be paid includes coupons which are redeemable for the full value of the currency. This reduces the number of times the universal box 52 must be removed from the game 12 and reduces the monetary instruments that must be handled by the casino personnel.

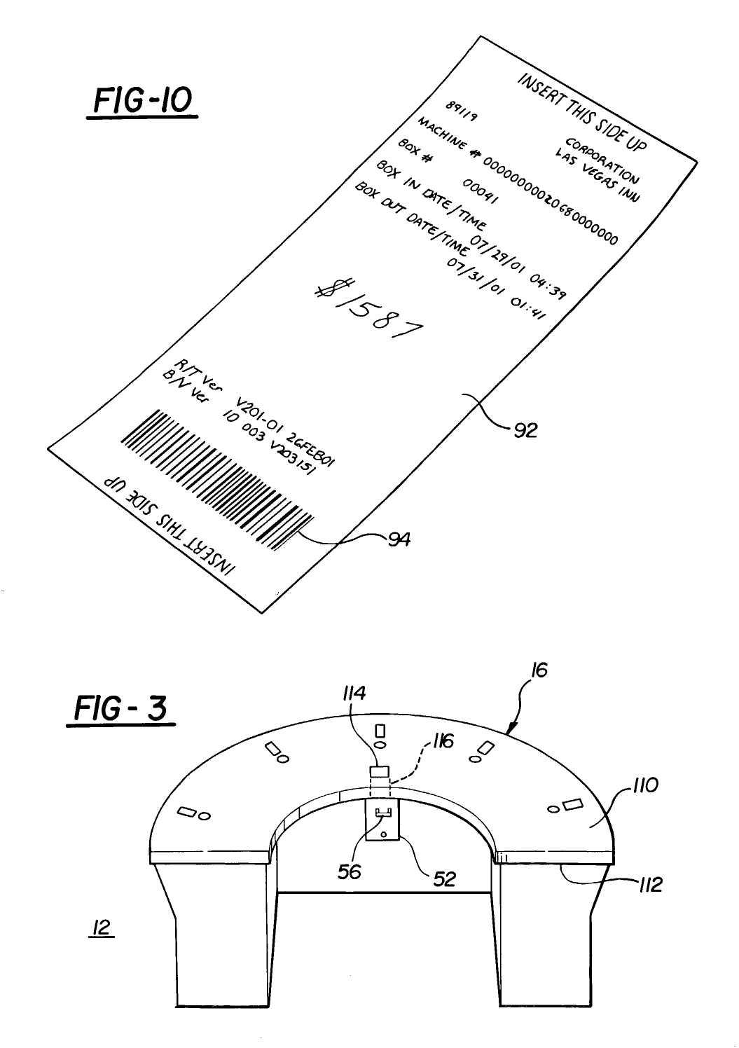

Another embodiment of the subject invention includes the closed system 10 adapted for receiving monetary instruments, such as currency, at the game table 16, as shown in FIG. 3. The game table 16 includes a gaming surface 108 having a top surface 110 and a bottom surface 112, and an orifice 114 within the gaming surface for passage of monetary instruments from the top surface through the orifice. Examples of game tables 16 include, but are not limited to, craps, roulette, black jack, poker, and baccarat. A collector 116 having a top open end and a bottom open end is positioned beneath the gaming surface such that the top open end is generally aligned with the orifice. Preferably, the collector 116 has a generally v-shaped cross section and the orifice 114 is a slot. The collector 116 is capable of receiving, monetary instruments, e.g., a stack of bills and validating the bills quickly and eliminating the need to feed the monetary instruments into the collector bill by bill. As the bills are verified, the bills are stored in the holding chamber 64 (see FIG. 4) of the universal box 52. The collector 116 also has a memory source 74 similar to the bill validator 72 of FIG. 2 for storing the game identification. The game identification would include the specific game type and the specific table. The memory source 74 of the collector 116 downloads the game identification to the universal box 52. The closed system includes an agitator (not shown) coupled to the collector 116, the agitator being adapted to provide motion to the collector 116 to facilitate alignment of monetary instruments as it passes through the collector 116.

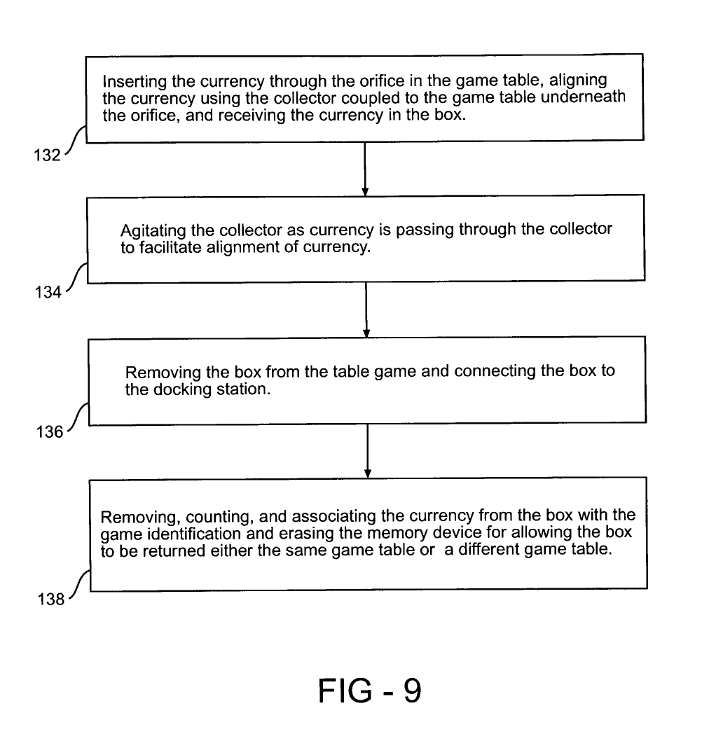

As shown in FIG. 9, the method provides for collecting monetary instruments, e.g., currency, at the game table 16. The method includes the steps of inserting the monetary instruments through the orifice 114 in the game table 16, aligning the monetary instruments using the collector 116 coupled to the game table 16 underneath the orifice 114, and, receiving the monetary instruments in the universal box 52 in step 132. The method further includes agitating the collector 116 as the monetary instruments is passed through the collector 116 to facilitate alignment of the monetary instruments in step 134. The universal boxes are then removed from the table games 12 and connected to the docking station 88 in step 136. The monetary instruments stored in the universal box 52 is removed, counted, and associated with the game identification. The memory device 58 is then erased allowing the universal box 52 to be returned either the same game table 16 or a different game table 16 in step 138. As discussed above, the universal box 52 may be inserted into the docking station 88 where the game ID and content information is read and then erased from the memory device 58. In one embodiment, the docking station 88 is connected to the counting machine 78. The monetary instruments may be automatically removed from the box 52 by the counting machine 78 as described above. Alternatively, the docking station 88 may be separate from the counting machine 78. The docking station 88 may also print a ticket counting the game ID and the content information which is read by the counting machine 78.

Another embodiment of the method provides for collecting monetary instruments in a gaming environment having at least one electronic game machine 14 and at least one game table 16. The method includes the steps of providing the universal boxes 52, inserting the universal boxes 52 into at least one electronic game machine 14 and at least one game table 16. The universal boxes 52 receive monetary instruments inserted into the electronic game machine 14 and the table 16. The monetary instruments is stacked and stored in the universal boxes 52. When the universal boxes 52 are removed, the monetary instruments are removed, counted, and associated with the game identification on the memory devices 58 on the network 82. The universal boxes 52 can now be inserted into other electronic game machines and game tables 16.

Obviously, many modifications and variations of the present invention are possible in light of the above teachings. The invention may be practiced otherwise than as specifically described within the scope of the appended claims.

What is claimed is:

1. A system for counting monetary instruments from a plurality of games, comprising:
a box for insertion into one of the games and for storing monetary instruments inserted into the one game;
a bill validator for accepting and validating the monetary instruments, the bill validator being adapted to communicate data to the box, the data related to the one game;
a memory device coupled to the box, the memory device being adapted to receive the data and to store the data when the box is inserted into the game; and,
a counting machine for receiving the monetary instruments stored in the box, receiving the data, counting the monetary instruments, and responsively determining a value, and for associating the data with the value, wherein the memory device is adapted to be erased after the monetary instruments have been removed and to be inserted into another of the games.

2. A system, as set forth in claim 1, wherein the bill validator is adapted to pay out monetary instruments to a player.

3. A system, as set forth in claim 2 wherein the bill validator further includes a bill retriever for accessing the monetary instruments within the bill validator and paying the monetary instruments to the player.

4. A system, as set forth in claim 1, wherein the bill validator further includes a collector for receiving a stack of the monetary instruments and validating the monetary instruments.

5. A system, as set forth in claim 4, further including an agitator coupled to the collector for agitating the stack of the monetary instruments to facilitate alignment of the monetary instruments as the monetary instruments are validated.

6. A system, as set forth in claim 1, wherein the game is an electronic game machine.

7. A system, as set forth in claim 1, wherein the game is a game table.

8. A system, as set forth in claim 1, including a docking station for receiving the box, reading the data from the memory device, printing a bar code containing the data, and erasing the memory device.

9. A system, as set forth in claim 8, including a bar code reader coupled to the counting machine for reading the bar code.

10. A system, as set forth in claim 1, including a receiving station coupled to the counting machine for reading the data from the memory device, removing the monetary instruments from the box, counting the monetary instruments, and liking the data with the counted monetary instruments.

11. A system, as set forth in claim 10, wherein the counting machine further includes a receptacle for receiving the monetary instruments from the holding chamber.

12. A system, as set forth in claim 11, wherein the receiving station is adapted to automatically disengage the locking mechanism and remove the monetary instruments from the holding chamber.

13. A system, as set forth in claim 1, wherein the memory device is further defined as a re-writeable memory device.

14. A system, as set forth in claim 1, further including a connector connected to the memory device for communicating with the bill validator and the counting machine.

15. A system, as set forth in claim 1, wherein the box further includes a display for displaying a status of the box and the game machine.

16. A system, as set forth in claim 1, wherein the box further includes sensors for indicating a predetermined capacity within the box.

17. A system, as set forth in claim 1, wherein the box further includes a holding chamber for receiving and storing the monetary instruments.

18. A system, as set forth in claim 17, wherein the monetary instruments are currency and the holding chamber further includes multiple slots for receiving different denominations of the currency.

19. A system, as set forth in claim 18, wherein the box further includes an access panel for removing currency from the holding chamber.

20. A system, as set forth in claim 19, further including a locking mechanism for securing the access panel and preventing theft of the currency.

21. A method for counting monetary instruments from a plurality of games, comprising:
inserting a box into one of the games;
communicating data from the bill validator to the box;
storing the data on a memory device when the box is inserted into the game;
accepting and validating the monetary instruments inserted into the one game using a bill validator, the bill validator being adapted to communicate data related to the one game to the box;
storing monetary instruments inserted into the game in the box;
removing the box from the game;
reading the data from the memory device;
erasing the data from the memory device;
transferring the monetary instruments to a counting machine, counting the monetary instruments using the counting machine and responsively determining a value;
associating the gaming identification with the value; and,
inserting the box into another one of the games.

22. A method, as set forth in claim 21, wherein the game is an electronic game machine.

23. A method, as set forth in claim 21, wherein the game is a game table.

24. A method, as set forth in claim 21, including the steps of:
inserting the box in a docking station; and,
printing a bar code by the docking station containing the data.

25. A method, as set forth in claim 24, including the step of reading the bar code by a bar code reader coupled to the counting machine.

26. A method, as set forth in claim 21, including the step of:
inserting the box in a docking station coupled to the counting machine; and,
reading the data from the memory device.

27. A method, as set forth in claim 26, wherein the reading of the data is further defined as reading a game identification from the memory device.

28. A method, as set forth in claim 26, wherein the reading of the data is further defined as reading accounting data from the memory device.

29. A method, as set forth in claim 21, further including the step of recycling the monetary instruments stored within the box.

30. A method, as set forth in claim 29, wherein the step of recycling the monetary instruments is further defined as accessing the monetary instruments in the game and paying out the monetary instruments the player.

31. A method, as set forth in claim 21, wherein the step of accepting the monetary instruments further includes accepting a stack of the monetary instruments and agitating the stack to align the monetary instruments for validation.

32. A method, as set forth in claim 21, further including sensing a predetermined limit of monetary instruments within the box and triggering an alarm to indicate the predetermined limit being reached.

33. A method, as set forth in claim 21, wherein the step of transferring the monetary instruments further includes inserting the box into a receiving station, automatically removing the monetary instruments from the box, downloading the data from the memory device, and linking the data with monetary instruments.
